(19) United States
(12) Patent Application Publication
(10) Pub. No.: US 2026/0045428 A1
(43) Pub. Date: Feb. 12, 2026

(54) KEY ASSEMBLY STRUCTURE

(71) Applicant: Primax Electronics Ltd., Taipei (TW)

(72) Inventors: Chuang-Shu Jhuang, Taipei (TW); Jie-Gang Guo, Taipei (TW); Lei-Lung Tsai, Taipei (TW)

(21) Appl. No.: 18/810,191

(22) Filed: Aug. 20, 2024

(30) Foreign Application Priority Data
Aug. 7, 2024 (CN) 202411076694.7

(51) Int. Cl. H01H 13/20; H01H 13/14

(52) U.S. Cl. CPC H01H 13/20; H01H 13/14

(57) ABSTRACT

A key assembly structure includes a scissor-type connecting component and a base plate. The scissor-type connecting component includes an inner frame and an outer frame configured to swing relatively, in which the inner frame has a first shaft, and the outer frame has a second shaft. The base plate is disposed beneath the scissor-type connecting component and has a set of first hooks corresponding to the first shaft and a set of second hooks corresponding to the second shaft. The set of first hooks or the set of second hooks includes two edge hooks and at least one auxiliary hook that extend outward and are configured to engage with two edge portions and a middle portion of the corresponding first shaft or the corresponding second shaft, respectively, and the middle portion is between the two edge portions.

### FIELD OF THE INVENTION

The present invention relates to a key assembly structure.

### BACKGROUND OF THE INVENTION

A base plate of a common key assembly structure on the market is usually made of stainless steel; however, its density is high and its weight is heavy. Therefore, the market has begun to use a material with lower density to manufacture the base plate; however, pull-out resistance of hooks of such base plate is not strong enough, and service life thereof is short, and thus it does not meet the needs. Therefore, a novel key assembly structure is currently needed to solve the above issues.

### SUMMARY OF THE INVENTION

The present invention provides a key assembly structure, which includes a scissor-type connecting component and a base plate. The scissor-type connecting component includes an inner frame and an outer frame configured to swing relatively, in which the inner frame has a first shaft, and the outer frame has a second shaft. The base plate is disposed beneath the scissor-type connecting component and has a set of first hooks corresponding to the first shaft and a set of second hooks corresponding to the second shaft. The set of first hooks or the set of second hooks includes two edge hooks and at least one auxiliary hook that extend outward and are configured to engage with two edge portions and a middle portion of the corresponding first shaft or the corresponding second shaft, respectively, and the middle portion is between the two edge portions.

In some embodiments of the present invention, a thickness of the middle portion of the first shaft is greater than a thickness of one of the two edge portions of the first shaft.

In some embodiments of the present invention, the middle portion or one of the two edge portions of the first shaft is connected to a peripheral portion of the inner frame, and a height of the peripheral portion is greater than a height of the middle portion or the one of the two edge portions.

In some embodiments of the present invention, the set of first hooks includes two first edge hooks and at least one first auxiliary hook, and one of the two first edge hooks or the at least one first auxiliary hook has a connecting surface that extends upward from the base plate and is configured to face an inner side surface of one of the two edge portions or the middle portion of the first shaft, and when the scissor-type connecting component is in an open state, there is a distance between the connecting surface and the inner side surface.

In some embodiments of the present invention, the one of the two first edge hooks or the at least one first auxiliary hook further has an inner top surface that is connected to the connecting surface and extends outward and configured to face an arc surface connected to the inner side surface of the one of the two edge portions or the middle section portion of the first shaft, and when the scissor-type connecting component is in the open state, a length of a portion of the arc surface that is in contact with the inner top surface is smaller than a length of another portion of the arc surface that is not in contact with the inner top surface.

In some embodiments of the present invention, the one of the two first edge hooks or the at least one first auxiliary hook further has an inner top surface that is connected to the connecting surface and extends outward and configured to face an arc surface connected to the inner side surface of the one of the two edge portions or the middle section portion of the first shaft, and when the scissor-type connecting component is in the open state, the arc surface is in contact with a portion of the inner top surface away from the connecting surface but not in contact with a portion of the inner top surface adjacent to the connecting surface.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is an appearance diagram of a key assembly structure according to an embodiment of the present invention.

FIG. 2 is a top view of an inner frame according to an embodiment of the present invention.

FIG. 3 is a top view of an outer frame according to an embodiment of the present invention.

FIG. 4 is a perspective view of a base plate according to an embodiment of the present invention.

FIG. 5 is a cross-sectional view of a first shaft of an inner frame and a corresponding edge hook when a scissor-type connecting component is in an open state according to an embodiment of the present invention.

FIG. 6 is a cross-sectional view of a first shaft of an inner frame and a corresponding auxiliary hook when a scissor-type connecting component is in an open state according to an embodiment of the present invention.

FIG. 7 is a cross-sectional view of a first shaft of an inner frame and a corresponding edge hook when a scissor-type connecting component is in a closed state according to an embodiment of the present invention.

FIG. 8 is a cross-sectional view of a first shaft of an inner frame and a corresponding auxiliary hook when a scissor-type connecting component is in a closed state according to an embodiment of the present invention.

FIG. 9 is a cross-sectional view of a second shaft of an outer frame and a corresponding edge hook when a scissor-type connecting component is in an open state according to an embodiment of the present invention.

FIG. 10 is a cross-sectional view of a second shaft of an outer frame and a corresponding auxiliary hook when a scissor-type connecting component is in an open state according to an embodiment of the present invention.

FIG. 11 is a cross-sectional view of a second shaft of an outer frame and a corresponding edge hook when a scissor-type connecting component is in a closed state according to an embodiment of the present invention.

FIG. 12 is a cross-sectional view of a second shaft of an outer frame and a corresponding auxiliary hook when a scissor-type connecting component is in a closed state according to an embodiment of the present invention.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, the base plate of the common key assembly structure on the market is usually made of stainless steel; however, its density is high and its weight is heavy. Therefore, the market has begun to use a material with lower density to manufacture the base plate; however, pull-out resistance of hooks of such base plate is not strong enough, and service life thereof is short, and thus it does not meet the needs. Specifically, the inventor found that after a keycap of a key structure made of an aluminum base plate was pulled several times, hooks of the base plate were severely deformed and had poor pull-out resistance, and a scissor-type connecting component left the hooks directly; during a rigorous lifetime test (the keycap of the key structure was struck tens of millions of times at a position corresponding to the hook), the hook was severely worn, causing the scissor-type connecting component to easily detach from the hook.

Accordingly, the present invention provides a key assembly structure, which includes a scissor-type connecting component having an inner frame and an outer frame, and a base plate, in which the base plate has a set of first hooks corresponding to a shaft (or called a sliding shaft) of the inner frame and a set of second hooks corresponding to a shaft (or called a rotation shaft) of the outer frame. The set of first hooks or the set of second hooks includes two edge hooks and at least one auxiliary hook that extend outward and are configured to engage with two edge portions and a middle portion of the corresponding shaft, respectively. The inventor found that since the base plate of the key assembly structure of the present invention has the edge hooks and the auxiliary hook, even if an extremely thin aluminum base plate (a thickness is less than 0.3 mm, such as 0.25 mm, 0.20 mm or thinner) is used, the key structure still has good pull-out resistance and has a long service life. Specifically, after the key structure is pulled several times, the hooks of the base plate have not deformed, and the scissor-type connecting component has not detached from the hooks; in a lifetime test, the hooks are not prone to serious wear, and the shafts of the scissor-type connecting component are not prone to wear, and the service life is significantly improved. On the other hand, compared with the currently common stainless steel base plate, the key assembly structure of the present invention can use the extremely thin aluminum base plate, so a total weight of the key structure is lower and a material cost thereof is lower. In addition, a manufacturing process of the base plate of the key assembly structure of the present invention does not require a plastic insert molding process, so a manufacturing cost is lower. Various embodiments of the key assembly structure of the present invention will be described in detail below.

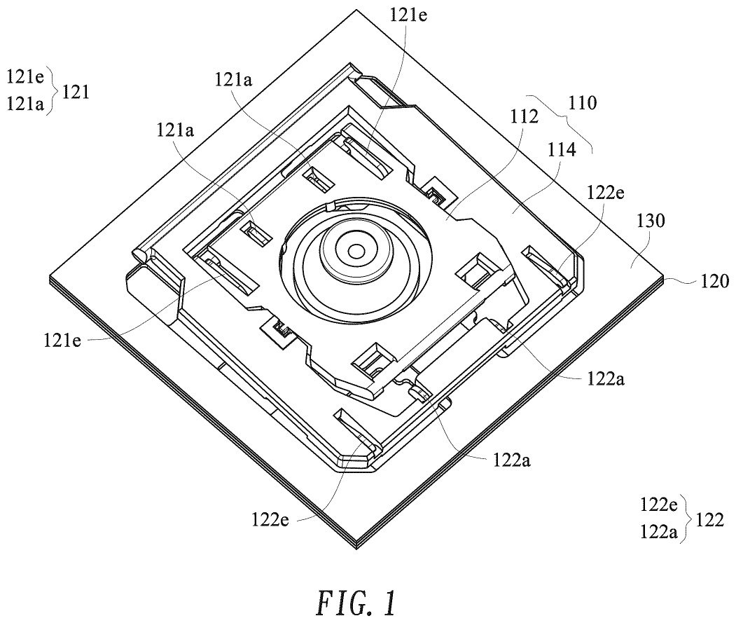

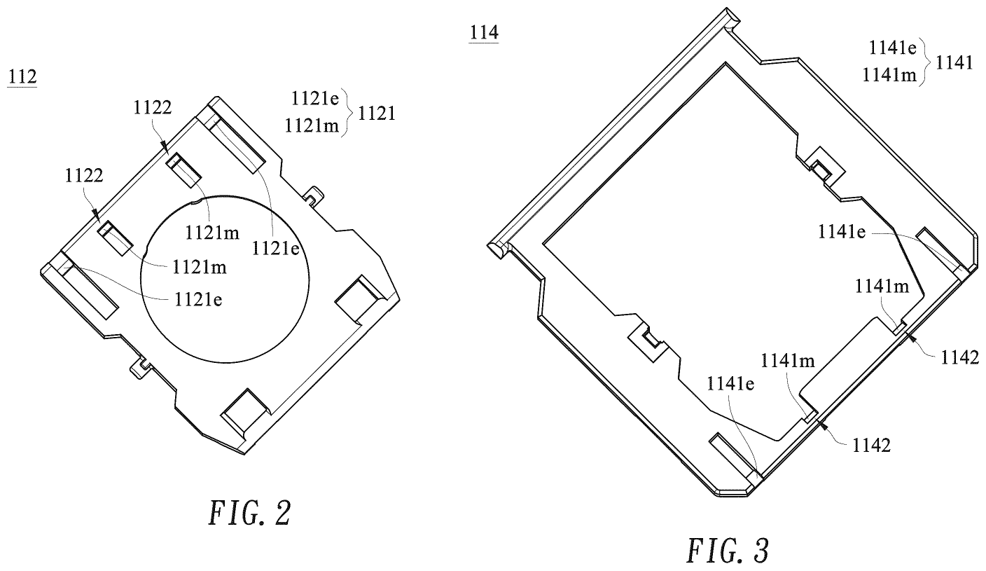

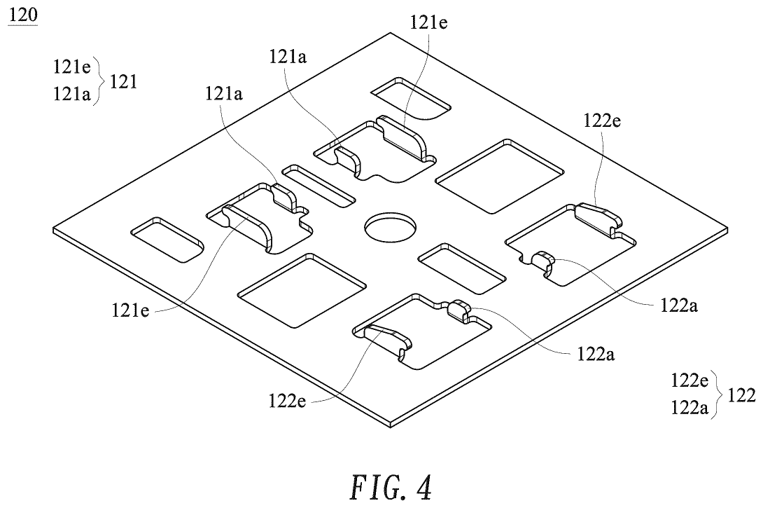

FIG. 1 is an appearance diagram of a key assembly structure according to an embodiment of the present invention. FIG. 2 is a top view of an inner frame according to an embodiment of the present invention. FIG. 3 is a top view of an outer frame according to an embodiment of the present invention. FIG. 4 is a perspective view of a base plate according to an embodiment of the present invention. As shown in FIGS. 1 to 4, the key assembly structure includes a scissor-type connecting component 110 and a base plate 120. In some embodiments, the base plate 120 is made of a low-density material (e.g., a material with a density lower than that of stainless steel), such as aluminum or plastic. In some embodiments, as shown in FIG. 1, the key assembly structure further includes a membrane circuit board 130. In some embodiments, the key assembly structure further includes a backlight module (not marked) located beneath the membrane circuit board 130.

As shown in FIGS. 1 to 3, the scissor-type connecting component 110 includes an inner frame 112 and an outer frame 114, which are configured to swing relative to each other. As shown in FIGS. 2 and 3, the inner frame 112 has a first shaft 1121, and the outer frame 114 has a second shaft 1141. In some embodiments, the first shaft 1121 is a sliding shaft, and the second shaft 1141 is a rotation shaft.

As shown in FIGS. 1 to 4, the base plate 120 is disposed beneath the scissor-type connecting component 110 and has a set of first hooks 121 corresponding to the first shaft 1121 of the inner frame 112 and a set of second hooks 122 corresponding to the second shaft 1141 of the outer frame 114. As shown in FIGS. 1, 2 and 4, the set of first hooks 121 includes two edge hooks (or called first edge hooks) 121e and at least one auxiliary hook (or called a first auxiliary hook) 121a, which extend outward and are configured to engage with two edge portions 1121e and a middle portion 1121m of the corresponding first shaft 1121, respectively. The middle portion 1121m is between the two edge portions 1121e. As shown in FIGS. 1, 3 and 4, the set of second hooks 122 includes two edge hooks (or called second edge hooks) 122e and at least one auxiliary hook (or called a second auxiliary hook) 122a, which extend outward and are configured to engage with two edge portions 1141e and a middle portion 1141m of the corresponding second shaft 1141, respectively. The middle portion 1141m is between the two edge portions 1141e.

In some embodiments, during the operation of the scissor-type connecting component 110, the first shaft 1121 of the inner frame 112 slides in the set of first hooks 121, and the second shaft 1141 of the outer frame 114 rotates in the set of second hooks 122.

The inventor found that the hooks of the current base plate need to have functions of limiting a height of the key and preventing the scissor-type connecting component from being detached; therefore, the hooks are subject to great stress and are easily deformed, worn or even broken. Therefore, in addition to adding the auxiliary hook 121a and/or the auxiliary hook 122a to share the stress, further, in some embodiments, the edge hooks 121e are designed to restrict the inner frame 112 from detaching in a Z-axis direction, and the auxiliary hook 121a is designed to restrict the inner frame 112 to limit a height of the key. As such, durability of the edge hooks 121e can be effectively improved. On the other hand, in order to facilitate the assembly between the scissor-type connecting component 110 and the base plate 120, in some embodiments, the auxiliary hook 121a has a shorter hook portion, so that the scissor-type connecting component 110 can be easily assembled to the base plate 120. Various embodiments of the inner frame 112 (the edge hooks 121e are designed to restrict the inner frame 112 from detaching in the Z-axis direction, and the auxiliary hook 121a is designed to restrict the inner frame 112 to limit the height of the key), the outer frame 114, the set of first hooks 121 and the set of second hooks 122 of the present invention will be described in detail below.

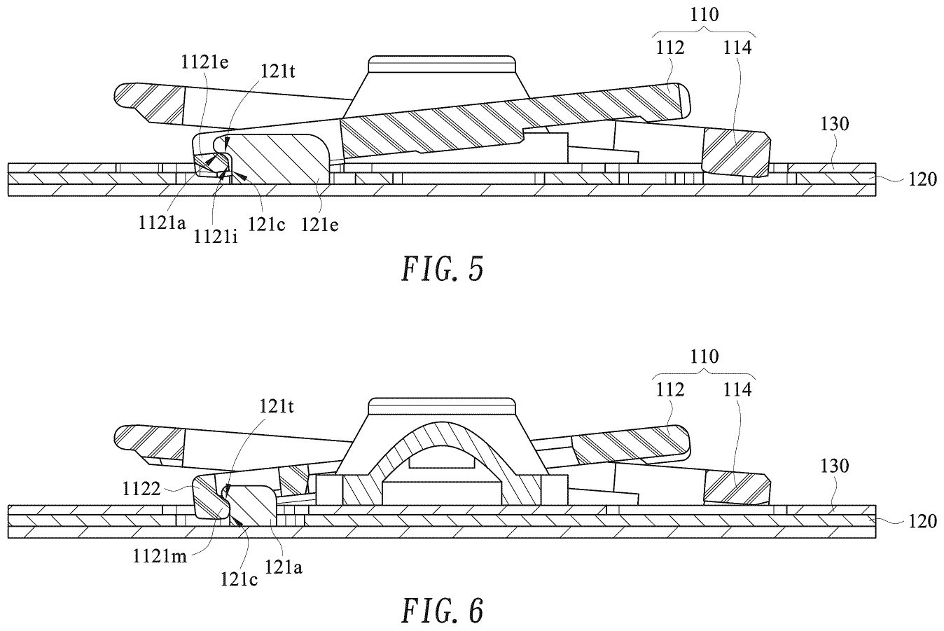

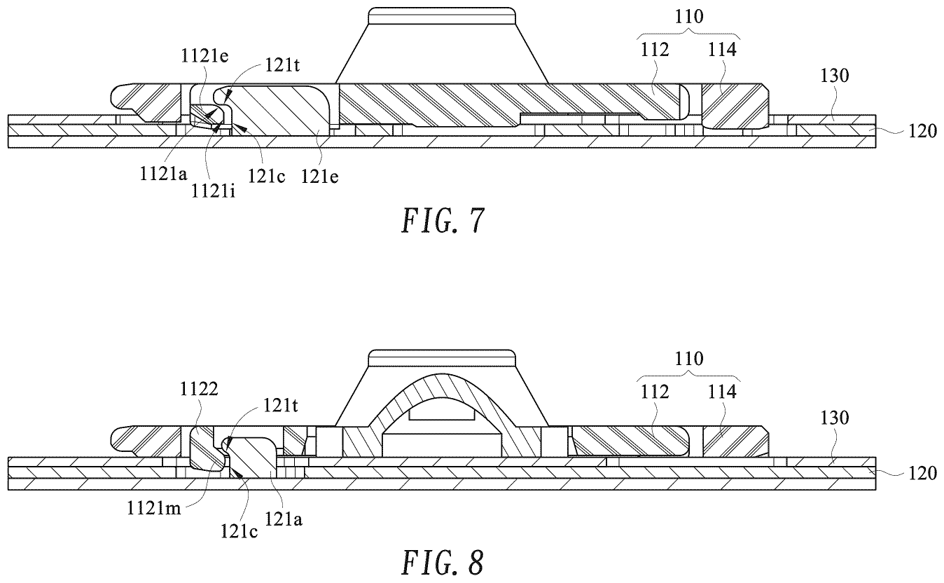

FIGS. 5 and 7 are cross-sectional views of the first shaft of the inner frame and the corresponding edge hook when the scissor-type connecting component is in an open state and a closed state, respectively. FIGS. 6 and 8 are cross-sectional views of the first shaft of the inner frame and the corresponding auxiliary hook when the scissor-type connecting component is in an open state and a closed state, respectively.

In some embodiments, as shown in FIGS. 4 and 5, each of the two edge hooks 121e has a connecting surface 121c extending upward from the base plate 120 and an inner top surface 121t connected to the connecting surface 121c and extending outward; as shown in FIG. 6, the at least one auxiliary hook 121a has a connecting surface 121c extending upward from the base plate 120 and an inner top surface 121t connected to the connecting surface 121c and extending outward.

In some embodiments, as shown in FIG. 5, the connecting surface 121c of the first edge hook 121e is configured to face an inner side surface 1121i of the edge portion 1121e of the first shaft, and when the scissor-type connecting component 110 is in the open state, there is a distance between the connecting surface 121c and the inner surface 1121i. That is, the connecting surface 121c of the first edge hook 121e does not touch the first shaft, so it does not limit an opening angle of the inner frame 112 and thus does not limit the height of the key.

In some embodiments, as shown in FIG. 5, the inner top surfaces 121t of the two first edge hooks 121e are configured to face arc surfaces 1121a, which are connected to the inner side surfaces 1121i of the edge portions 1121e of the first shaft, and when the scissor-type connecting component 110 is in the open state, a length of a portion of the arc surface 1121a that is in contact with the inner top surface 121t is smaller than a length of another portion of the arc surface 1121a that is not in contact with the inner top surface 121t. In some embodiments, when the scissor-type connecting component 110 is in the open state, the arc surface 1121a is in contact with a portion of the inner top surface 121t away from the connecting surface 121c but is not in contact with a portion of the inner top surface 121t adjacent to the connecting surface 121c.

In some embodiments, as shown in FIG. 6, when the scissor-type connecting component 110 is in the open state, the connecting surface 121c of the first auxiliary hook 121a touches the middle portion 1121m of the first shaft, so it can limit the opening angle of the inner frame 112 to limit the height of the key.

Referring to FIGS. 2 and 6, since the auxiliary hook 121a is designed to limit the inner frame 112, when the keycap is pulled, the middle portion 1121m of the first shaft of the inner frame 112 is subjected to a greater stress, so that in some embodiments, the middle portion 1121m is thickened and/or the middle portion 1121m is connected to a peripheral portion 1122 to increase its strength. Therefore, in some embodiments, as shown in FIGS. 5 and 6, a thickness of the middle portion 1121m of the first shaft is greater than a thickness of one of the two edge portions 1121e of the first shaft. In some embodiments, as shown in FIGS. 2 and 6, the middle portion 1121m of the first shaft 1121 is connected to the peripheral portion 1122 of the inner frame 112, and a height of the peripheral portion 1122 is greater than a height of the middle portion 1121m. However, the present invention is not limited to the above embodiments. The shape and size of the peripheral portion 1122 can be appropriately adjusted to improve the strength of the middle portion 1121m.

However, it should be noted that features of the edge hooks and the auxiliary hook can be interchanged, and features of the middle portion and the edge portions of the shaft that cooperate with them also need to be interchanged to achieve corresponding functions, that is, in other embodiments, the edge hooks can be designed to restrict the inner frame to limit the height of the key, and the auxiliary hook can be designed to restrict the inner frame from detaching in the Z-axis direction. Therefore, the structure of the edge hooks can be, for example, the structure of the auxiliary hook 121a shown in FIG. 6, and embodiments thereof can be the same as the embodiments of the auxiliary hook 121a shown in FIG. 6, and the structure of the auxiliary hook can be, for example, the structure of the edge hook 121e shown in FIG. 5, and embodiments can be the same as the embodiments of the edge hook 121e shown in FIG. 5. As such, when the keycap is pulled, the edge portion of the first shaft of the inner frame is subjected to a greater stress, so the edge portion can be thickened and/or connected to the peripheral portion to increase its strength. In other embodiments, the structure of the edge portion of the first shaft may be, for example, the structure of the middle portion 1121m shown in FIG. 6. In other embodiments, a thickness of the edge portion is greater than a thickness of the middle portion. In other embodiments, the edge portion is connected to the peripheral portion, and a height of the peripheral portion is greater than a height of the edge portion.

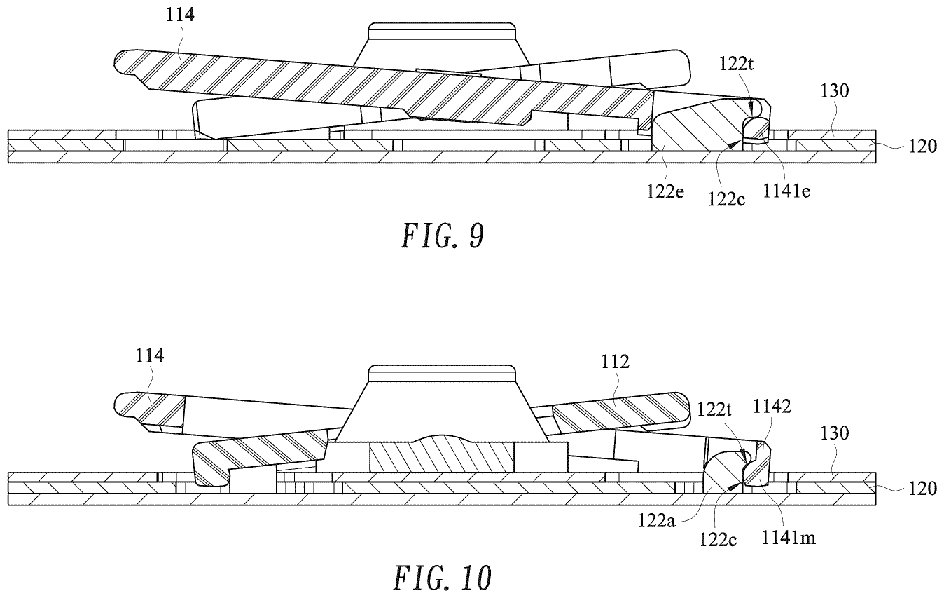

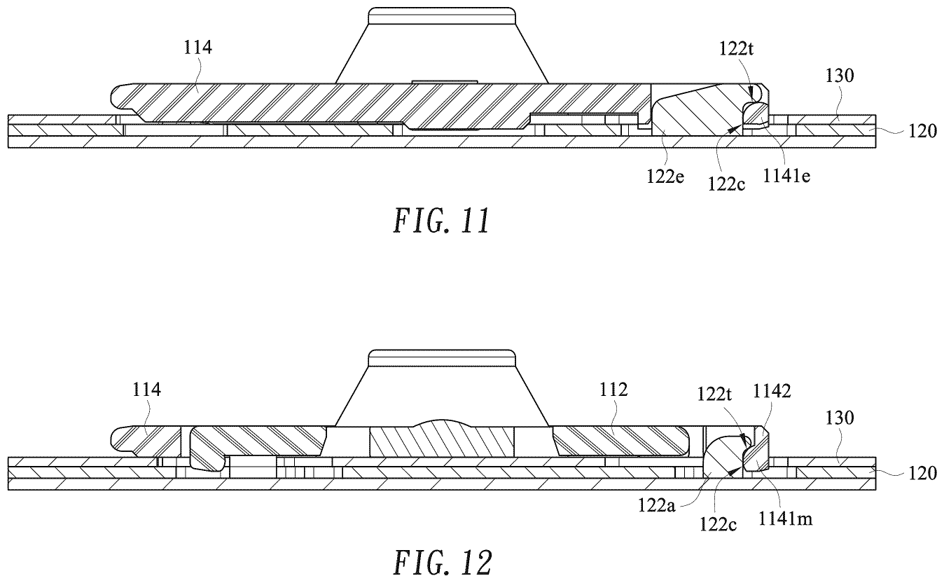

FIGS. 9 and 11 are cross-sectional views of the second shaft of the outer frame and the corresponding edge hook when the scissor-type connecting component is in an open state and a closed state, respectively. FIGS. 10 and 12 are cross-sectional views of the second shaft of the outer frame and the corresponding auxiliary hook when the scissor-type connecting component is in an open state and a closed state, respectively.

In some embodiments, as shown in FIGS. 4 and 9, each of the two edge hooks 122e has a connecting surface 122c extending upward from the base plate 120 and an inner top surface 122t connected to the connecting surface 122c and extending outward; as shown in FIG. 10, the at least one auxiliary hook 122a has a connecting surface 122c extending upward from the base plate 120 and an inner top surface 122t connected to the connecting surface 122c and extending outward.

Referring to FIGS. 3 and 10, in some embodiments, the middle portion 1141m is thickened and/or the middle portion 1141m is connected to a peripheral portion 1142 to increase its strength. Therefore, in some embodiments, as shown in FIGS. 9 and 10, a thickness of the middle portion 1141m of the second shaft is greater than a thickness of one of the two edge portions 1141e of the second shaft. In some embodiments, as shown in FIGS. 3 and 10, the middle portion 1141m of the second shaft is connected to the peripheral portion 1142 of the outer frame 114, and a height of the peripheral portion 1142 is greater than a height of the middle portion 1141m. However, the present invention is not limited to the above embodiments. The shape and size of the peripheral portion 1142 can be appropriately adjusted to improve the strength of the middle portion 1141m. In other embodiments, the edge portion of the second shaft can be thickened or the edge portion of the second shaft can be connected to the peripheral portion of the second shaft to increase its strength.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. A key assembly structure, comprising:
a scissor-type connecting component, comprising an inner frame and an outer frame configured to swing relatively, wherein the inner frame has a first shaft, and the outer frame has a second shaft; and
a base plate, disposed beneath the scissor-type connecting component and having a set of first hooks corresponding to the first shaft and a set of second hooks corresponding to the second shaft, wherein the set of first hooks or the set of second hooks comprises two edge hooks and at least one auxiliary hook that extend outward and are configured to engage with two edge portions and a middle portion of the corresponding first shaft or the corresponding second shaft, respectively, and the middle portion is between the two edge portions.

2. The key assembly structure of claim 1, wherein a thickness of the middle portion of the first shaft is greater than a thickness of one of the two edge portions of the first shaft.

3. The key assembly structure of claim 1, wherein the middle portion or one of the two edge portions of the first shaft is connected to a peripheral portion of the inner frame, and a height of the peripheral portion is greater than a height of the middle portion or the one of the two edge portions.

4. The key assembly structure of claim 1, wherein the set of first hooks comprises two first edge hooks and at least one first auxiliary hook, and one of the two first edge hooks or the at least one first auxiliary hook has a connecting surface that extends upward from the base plate and is configured to face an inner side surface of one of the two edge portions or the middle portion of the first shaft, and when the scissor-type connecting component is in an open state, there is a distance between the connecting surface and the inner side surface.

5. The key assembly structure of claim 4, wherein the one of the two first edge hooks or the at least one first auxiliary hook further has an inner top surface that is connected to the connecting surface and extends outward and configured to face an arc surface connected to the inner side surface of the one of the two edge portions or the middle section portion of the first shaft, and when the scissor-type connecting component is in the open state, a length of a portion of the arc surface that is in contact with the inner top surface is smaller than a length of another portion of the arc surface that is not in contact with the inner top surface.

6. The key assembly structure of claim 4, wherein the one of the two first edge hooks or the at least one first auxiliary hook further has an inner top surface that is connected to the connecting surface and extends outward and configured to face an arc surface connected to the inner side surface of the one of the two edge portions or the middle section portion of the first shaft, and when the scissor-type connecting component is in the open state, the arc surface is in contact with a portion of the inner top surface away from the connecting surface but not in contact with a portion of the inner top surface adjacent to the connecting surface.
